(19) United States
(12) Patent Application Publication
(10) Pub. No.: US 2024/0135767 A1
(43) Pub. Date: Apr. 25, 2024

(54) SYSTEM AND METHODS FOR MATCHING INCIDENTS TO A NUMBER SET

(71) Applicant: Entain Marketing (UK) Ltd., London (GB)

(72) Inventor: Clifford Adelman, Montreal (CA)

(73) Assignee: Entain Marketing (UK) Ltd., London (GB)

(21) Appl. No.: 17/984,646

(22) Filed: Nov. 10, 2022

Related U.S. Application Data
(60) Provisional application No. 63/418,803, filed on Oct. 24, 2022.

(51) Int. Cl. G07C 15/00; G07F 17/32

(52) U.S. Cl. CPC G07C 15/006; G07F 17/323; G07F 17/3288; G07F 17/329

(57) ABSTRACT

The present invention relates generally to a system and methods for matching timed incidents in an event with a number set. The system and methods may compare user-selected numbers to other numbers, such as those representing minutes in which incidents occur during an event having a duration. Due to the unpredictable amount of incidents that may occur during an event, the system may utilize a variable table for determining returns. Advantageously, the system and methods may provide for fuller and more interactive user experiences.

### CROSS-REFERENCE TO RELATED APPLICATION

This application claims benefit of U.S. Application No. 63/418,803 filed on Oct. 24, 2022, which is incorporated by reference in its entirety.

### FIELD OF INVENTION

The present invention relates generally to a system and methods for matching incidents in an event having a duration and, more specifically, to a system and methods by which results of a timed event are mapped to a number set.

### BACKGROUND OF THE INVENTION

In a typical activity for matching one or more selected numbers to one or more drawn numbers, which may involve an array, users select one or more numbers from a series or sequence of numbers. Numbers subsequently are drawn either manually or automatically, such as via a computer program. A desired outcome for the user occurs when the user's selection or selections match one or more drawn numbers.

For example, an objective in keno is for a user or player to choose ultimately winning or rewarded numerals from a set of numerals. Typically, a user is presented with a card—such as a paper card or a virtual card—having an array of eighty numbered squares. The user can select any number of numerals up to a designated or predetermined quantity of numerals, e.g., such as ten numerals. The user generally places a real or fictitious sum on each numeral or number selected.

Once the user has made their selection and placed their sums, a predetermined set of numbers may be drawn. For instance, numbered balls corresponding to squares on a keno card may be spun around in a drum, from which an operator may randomly draw twenty numbered balls. Alternatively, a computer may generate the twenty drawn keno numbers using a random number generator. After the twenty numbers are drawn, rewards are returned according to a fixed payout or returns table. In other words, as a result of drawing a predetermined set of numbers, conventional keno relies on a fixed returns table, which often provides expected returns that are relatively constant.

Keno and other similar activities are popular since they are simple and offer enticing prizes. One drawback, however, is that the activities are, in a sense, one-dimensional. Users merely select their numbers and wait a set of numbers to be drawn. Generally, there is no strategy or interaction to maintain the user's interest.

Accordingly, there is a need for an improved matching system and methods that facilitate interaction and development during the activity and provide a better and fuller experience for the user.

### SUMMARY OF THE INVENTION

The present invention relates generally to matching and, more specifically, to a matching system and methods by which results of a particular sporting event may be obtained to facilitate defining one or more drawn numbers from a number set. The system may then determine one or more rewarding numbers by comparing user-selected numbers to the drawn numbers. The drawn number may be determined by a timed incident such as the scoring of a goal. Advantageously, the system may provide for a more interactive matching experience.

In operation, the system may be configured to generate an array, matrix, or board including a number set. The system may output the array to a user, such as via a graphical user interface. The system may then receive one or more inputs corresponding to a selection of the one or more numbers from the numbers set. Further, the system may define one or more drawn numbers from the number set. Drawn numbers may be based on event results.

The system may be configured also to compare the user-selected numbers and drawn numbers to identify one or more rewarding numbers. In other words, user-selected numbers that match drawn numbers may be classified as rewarding numbers. Once the rewarding numbers are determined, the system may credit, a user account according to a variable returns table.

In one aspect, the number set of an array may correspond to minutes of a regulation time of a sporting match. For instance, the system may generate an array having sixty numbered squares for a hockey match. Other examples of sporting events for which the system may generate an array may include, but are not limited to, a soccer match, a lacrosse match, a football match, basketball match, and a water polo match. It is further contemplated that the event may be a competitive video game—such as an online or “eSports” event—corresponding to a sporting match. The system may further be operative to obtain event results, such as from a third party feed, from a trusted source, or via manual user inputs. The drawn numbers defined by the system may correspond to a time of each of the one or more goals scored during an associated event. The system may round the time to a numeral, that is, an integer.

Further, the system may be configured to output a variable returns table. The returns table may be variable based on the one or more numbers selected, the one or more drawn numbers, and the one or more rewarding numbers. It is also contemplated that the numbers relied on by the variable returns table correspond to numbers that the system may be configured to emphasize on the array. Furthermore, the system may calculate a return based on the odds defined by the variable returns table. For example, the system may multiply the defined odds by a user sum to calculate a return.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to limit the present invention, where like designations denote like elements, and in which:

FIG. 1 is a schematic diagram illustrating an operation of a system for matching timed incidents to a number set;

FIG. 2 is a flow chart illustrating an exemplary operation of a system for matching timed incidents;

FIG. 3 is a flow chart illustrating an exemplary operation for displaying an array to a user of the system;

FIG. 4 is a flow chart illustrating an exemplary operation for receiving user inputs;

FIG. 5 is a flow chart illustrating an exemplary operation for defining one or more drawn numbers;

FIG. 6 is a flow chart illustrating an exemplary operation for determining one or more rewarding numbers;

FIG. 7 is an exemplary user interface of an exemplary list of sporting events;

FIG. 8 is an exemplary user interface of an array of the system for a hockey match;

FIG. 9 is an exemplary user interface of an array of the system for a soccer match including a returns table corresponding to ten goals scored during the match;

FIG. 10 is an exemplary user interface of an array of the system for a soccer match including a returns table corresponding to three goals scored during the match;

FIG. 11 is an exemplary card of the system;

FIG. 12A is an exemplary output board of the system illustrating user-selected numbers, drawn numbers, and rewarding numbers;

FIG. 12B is an exemplary output card of the system illustrating user-selected numbers, drawn numbers, and rewarding numbers;

FIG. 13A is an exemplary variable returns table corresponding to four goals and three user-selected numbers;

FIG. 13B is an exemplary variable returns table corresponding to four goals and eight user-selected numbers;

FIG. 13C is an exemplary variable returns table corresponding to eight goals and three user-selected numbers;

FIG. 14 is an exemplary computing system that may be used for implementation of all or a portion of the invention; and

FIG. 15 is an exemplary cloud computing system that may be used for implementation of all or a portion of the invention.

### DETAILED DESCRIPTION

The present disclosure relates generally to matching and, more specifically, to a system for matching timed incidents and methods by which results of a particular timed sporting event may be mapped to an array to define one or more drawn numbers. The drawn numbers may correspond to minutes in which incidents occur during an event having a duration. The system may then determine rewarding numbers by comparing user-selected numbers to the drawn numbers. Advantageously, the system may be configured to process information efficiently and effectively to credit a user account according to a variable returns table.

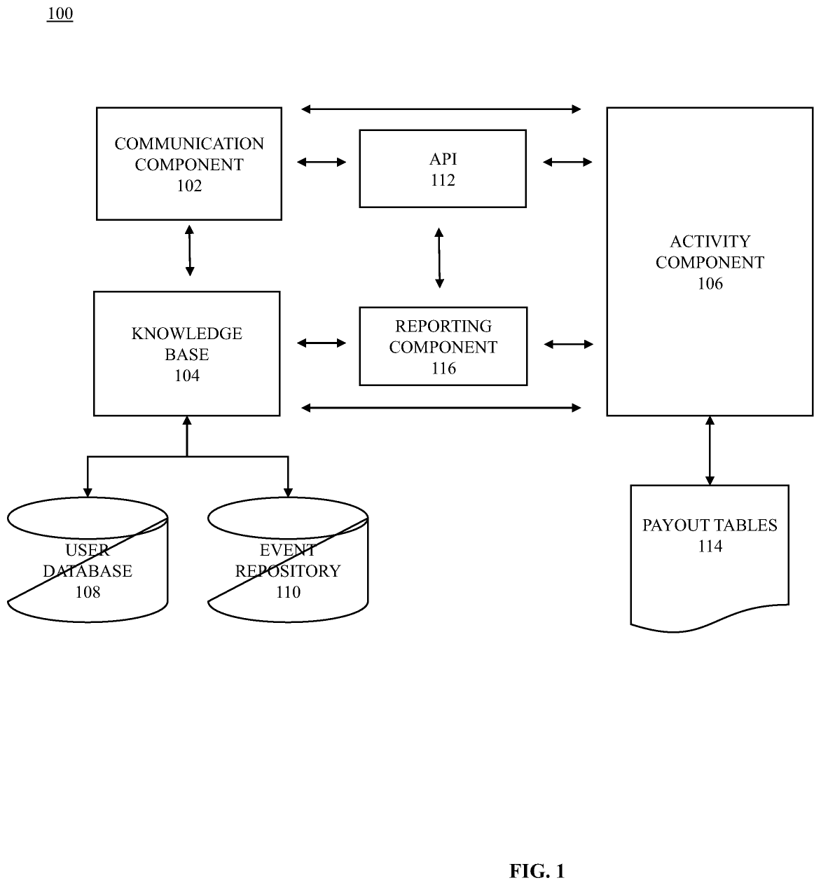

FIG. 1 illustrates an exemplary system 100 for an experience for matching timed incidents to a number set according to one or more embodiments. As shown, system 100 may include a communication component 102 that interoperates with a knowledge base 104 and an activity component 106 for matching timed incidents to a number set. While illustrated as separate interoperating systems, it is contemplated that the components of system 100 may be subsystem components of a single integrated system.

Communication component 102 may be configured to receive, obtain, and/or transmit information. Information may correspond to user inputs including, for example, an identity of the user, a selection, a sum, an event associated with the selection or sum, and the like. Furthermore, information received by communication component 102 may correspond to an event such as a sporting event. Event information may include, but is not limited to, a type of event, status of the event, a result of the event, and one or more times associated with the results, such as the times of goals scored during the event. Further, system 100 may communicate various information to a user by integrating with a communication platform, such as Instant Messaging (IM), text messaging (SMS), or WebRTC (Web Real-Time Communication) software.

Knowledge base 104 provides access to data corresponding to information received by communication component 102. Based on the information received, the system 100 may be configured to store that information in a user database 108 and/or an event repository 110. For example, user database 108 may include credentials corresponding to a user account. In one aspect, a user can register by linking their account with an existing account from a third party platform, such as Google, Facebook, or Twitter. In addition, a user may create an account by inputting an identifier and a password. If no uses of the same identifier are detected, then the system may store the entered user identifier and password for a newly registered user. Additional information stored by database 108 may include, for example, age, contact information, occupation, and the like.

Furthermore, database 108 may include information corresponding to credits or funds associated with a user account. Occasionally, a user may wish to transfer funds from a bank account into their user account via system 100. To do so, system 100 may receive inputs corresponding to a transfer amount and a personal identification code. This information may be transmitted via communication 102 to an appropriate bank facility, which may verify and authorizes the transfer of the selected amount of funds from the bank account into the user's account.

Event repository 110 may be configured to collect and store event data. Event data may be input manually into system 100 or automatically obtained, via communication component 102, from an external source, such as from a real-time data feed. Examples of an event may include a timed sporting event such as soccer, hockey, lacrosse, water polo, football, basketball, and the like. Furthermore, it is contemplated that the event may be a competitive video game—such as an online or “eSports” event—corresponding to a sporting match. Information stored in repository 110 may include whether a sporting event has begun, time remaining, the score, time each goal was scored, and various other information relating to the event. In addition, repository 110 may include accessing and/or viewing information—such as a link to a live or recorded video—that may be presented to the user via communication component 102.

Information relating to users and events may be created via a graphical user interface, as discussed below, and maintained by knowledge base 104 using any suitable types of data structures, including the use of any suitable data storage or database techniques. In some examples, the information may be maintained in a relational database in which pieces of information for user accounts and event data may be stored distinctly from one another, but are related to or otherwise associated with particular information in the relational database. Other types of storage techniques are contemplated for generating and maintaining the information within knowledge base 104.

As shown in FIG. 1, communication component 102 may further interoperate with component 106 for matching timed incidents to a number set. The interaction between communication component 102 and the component 106, and that which results from that interaction may be facilitated using an applications program interface (“API”) 112. In particular, API 112 may facilitate the bi-directional association between the information from database 108 and repository 110, which may be provided through knowledge base 104.

Component 106 may be configured to generate an array based on information received via communication component 102 and/or the information stored in knowledge base 104. For instance, knowledge base 104 may provide access to templates to support the creation of an array, including the generating of graphical icons or other user interface elements and the presentation of stored information via a screen display or graphical user interface.

More specifically, and as discussed in detail below, component 106 may be configured to identify an event, create an array including a number set corresponding to the event, recognize user-selected numbers from the number set, emphasize selected numbers on array, manage sums received from users, identify drawn numbers, determine rewarding numbers, credit user accounts, and the like.

In addition, component 106 may include one or more sets of rules. Rules may be suitable to the activity selected by a user and/or the corresponding event. For instance, rules may be used to determine or define drawn numbers from a number set. Further, rules applied to one sporting event, such as hockey, may differ from rules applied to another sporting event, such as soccer. Exemplary rules applied by component 106 may include a number set is based on regulation time of sporting event (e.g., sixty minutes for hockey and ninety minutes for soccer), an array may include spots for extra time (e.g., injury time), multiple goals scored in same minute count as one drawn number, empty net goals do not count, and a returns table may be determined based on the total number of goals scored in the match, a quantity of user-selected numbers, and a quantity of drawn numbers.

Component 106 may further be configured to access one or more variable returns table 114 to, for example, automatically calculate odds based on one or more parameters. Examples of parameters used or mapped as inputs into variable returns table 114 may include the one or more numbers selected by a user, the one or more drawn numbers defined based on event results, and the one or more rewarding numbers determined by comparing the selected numbers to the drawn numbers.

In the illustrated exemplary system 100 of FIG. 1, a reporting component 116 may be configured to capture a generated array, variable returns table, and related information for outputting to the user in substantially real-time and/or at the conclusion of a corresponding event. Reporting component 116 may be configured to present an array including, for example, information pertaining to the user and event, graphical icons corresponding to selected, drawn, and rewarding numbers, and/or a return or return odds based on the variable returns table. The array may then be output via communication component 102 to the corresponding user, such as through use of a mobile or web application.

Exemplary Flow Charts

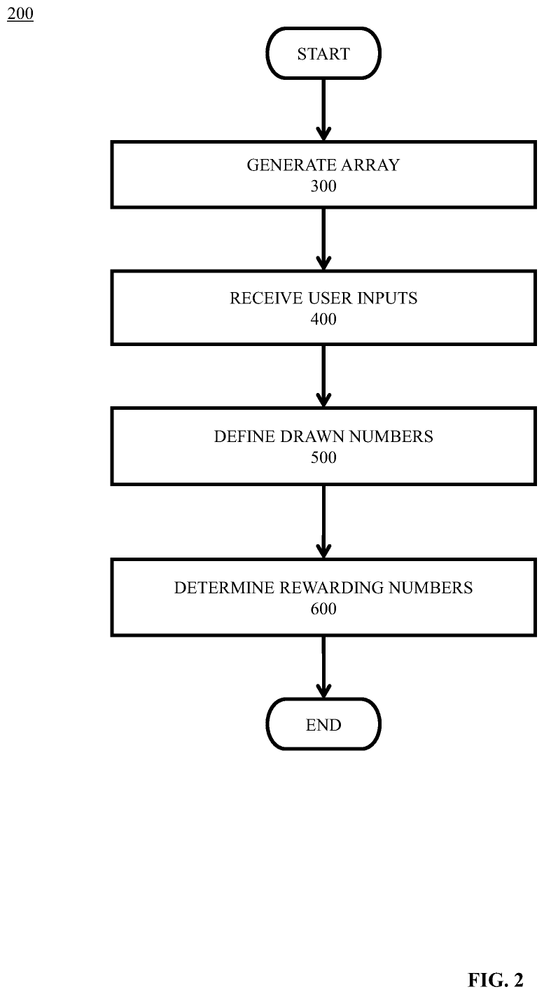

FIG. 2 is a flowchart 200 illustrating the steps of an exemplary operation of a system for matching timed incidents, such as system 100. The method of operation begins and, in step 300, the system may generate an array including a number set. In one aspect, the number set may be based on one or more rules corresponding to an event. In step 400, the system may receive one or more user inputs corresponding to the array. In step 500, the system may define one or more drawn numbers from the number set. In step 600, the system may determine rewarding numbers from the number set.

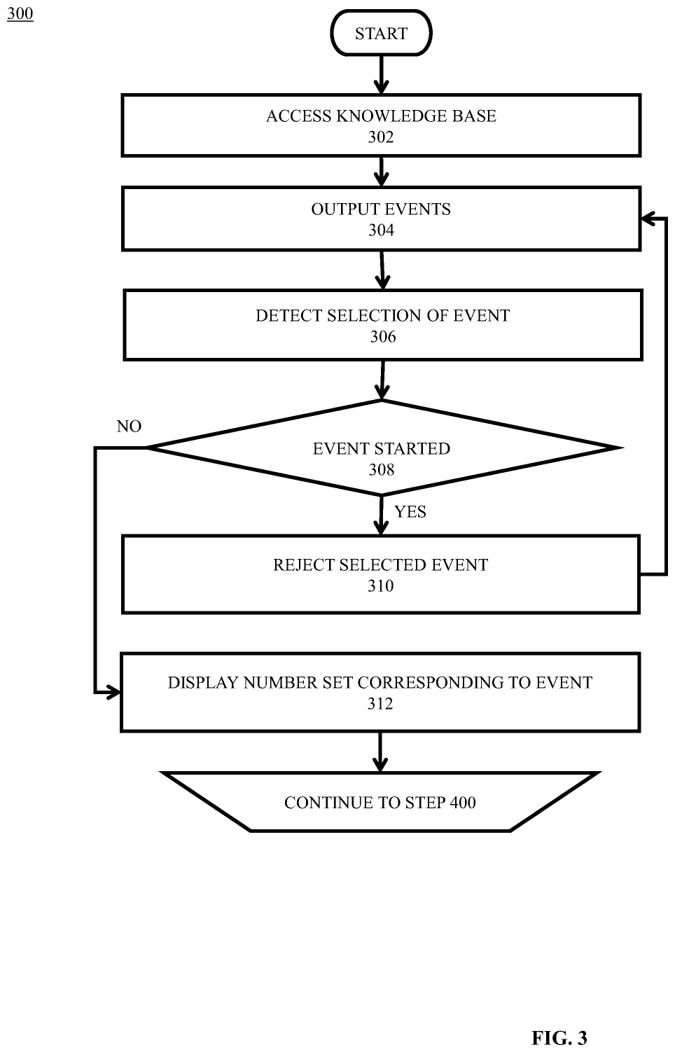

FIG. 3 is a flowchart providing more detail of step 300 of FIG. 2. The operation begins and, in step 302, the system may access a knowledge base including information corresponding to one or more events, such as a hockey, soccer, lacrosse, water polo, football, basketball, and other timed sporting events. As mentioned above, the event may also be a competitive video game—such as an online or “eSports” event—corresponding to a sporting match. In step 304, the system may output a list of sporting events that the system may use for interactive activity. In step 306, the system will detect a user selection corresponding to an output event. In decision step 308, the system will determine whether the selected event has started. The selected event may correspond to an entire sporting event or to a specific duration of a sporting event, such as a period, halftime, and overtime.

If at decision step 308, the system determines that the selected event has started, in step 310, the system may reject the users selection and revert back to step 304. If at decision step 308, the system determines that the selected event has not started, in step 312, the system may display a number set corresponding to the event and/or one or more set of rules. For instance, the number set may include rows and columns of numbers corresponding to a regulation time of the selected event. As discussed above, the selected event may correspond to a portion of a sporting match. For instance, the system may, in response to detecting a selection of a sporting match during a first half, display a number set corresponding to the second half of the match, such as from minutes forty five to ninety plus injury time for a soccer match.

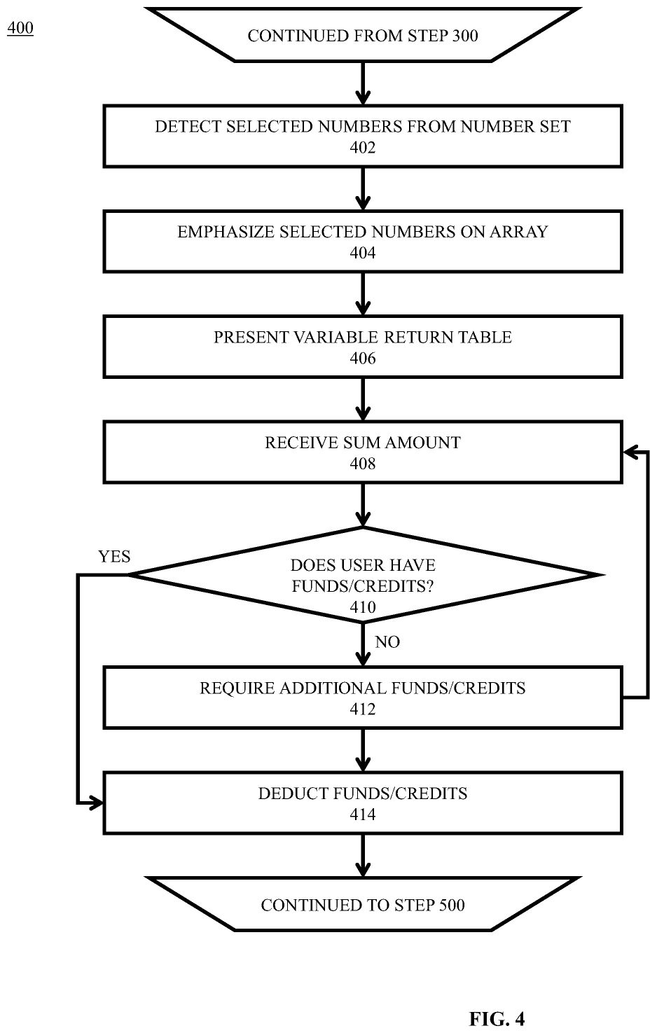

FIG. 4 is a flowchart providing more detail of step 400 of FIG. 2. The operation is continued from step 300 of FIG. 2 and, in step 402, the system may be configured to detect numbers selected from the number set, such as by a user via a user interface. In step 404, the system may emphasize selected numbers on an array, as detailed below. The display may include a field divided into a certain quantity of numbers icons arranged in rows, columns or diagonals. In step 406, the system may be configured to present a variable returns table. Variable returns table may include return odds based on, for example, the selected numbers from a number set, the quantity of numbers drawn, and the quantity of matching selected numbers and drawn numbers.

In step 408, the system may receive a number corresponding to a sum. In decision step 410, the system may determine whether the associated user account has enough funds or credits. While the present disclosure may be directed to online gaming, a “free option” is contemplated. For instance, freemium users may earn “credits” by performing certain tasks or via a referral program. If at decision step 410, the system determines that the user does not have enough funds or credits, in step 412, the system will require the user to add funds or credits, such as via a pop-out or dropdown controls. Dropdown controls may permit a user to select one or more actions or options, such as authorizing the transfer of a selected amount of funds from a bank into the user's account. If at decision step 410, the system determines that the user does have enough funds or credits to make the corresponding sum, in step 414, the system may deduct the corresponding funds and/or credits from the users account and the operation may continue to step 500.

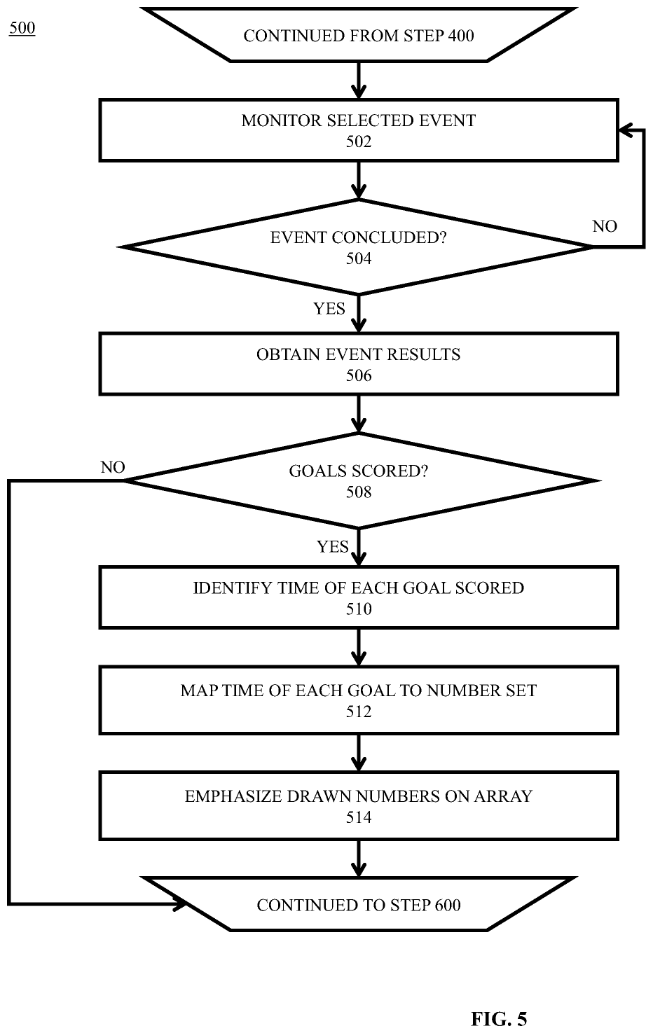

FIG. 5 is a flowchart providing more detail of step 500 of FIG. 2. The operation is continues from step 400 of FIG. 2 and, in step 502, the system may be configured to monitor the selected event. In decision step 504, the system may determine whether the event has concluded. If not, the system will revert back to step 502 and continue monitoring the selected event. As discussed below, however, the system may be configured to obtain results dynamically at any time between the start of an event and its conclusion. If at decision step 504, the system determines that the event has concluded, in step 506, the system may be configured to obtain event results. For example, the system may obtain event results from a third party feed, from a trusted source (e.g., ESPN) or via a user input that the system receives. In decision step 508, the system may determine whether any goals were scored during the event.

If at decision step 508, the system determines that no goals were scored, the operation may pass to step 600. If at decision step 508, the system determines that at least one goals was scored, in step 510, the system may identify the time of each goal scored. The time of each goal scored may be identified based on a set of rules accessible to the system. For example, in a soccer match, a goal scored at twenty-three minutes and four seconds may be recorded as a goal scored in the twenty-fourth minute. In another example, two or more goals scored in the same minute only count as one goal. In step 512, the system may map the recorded time of each goal to the number set on the array. In step 514, the system may emphasize drawn numbers on the array based on a recorded time of each goal. In other words, a goal recorded in the twenty-fourth minute will correspond to the number twenty-four in a number set. The number twenty-four may then be emphasized, such as via highlighting or an overlay of a graphical icon to indicate that the number has been drawn.

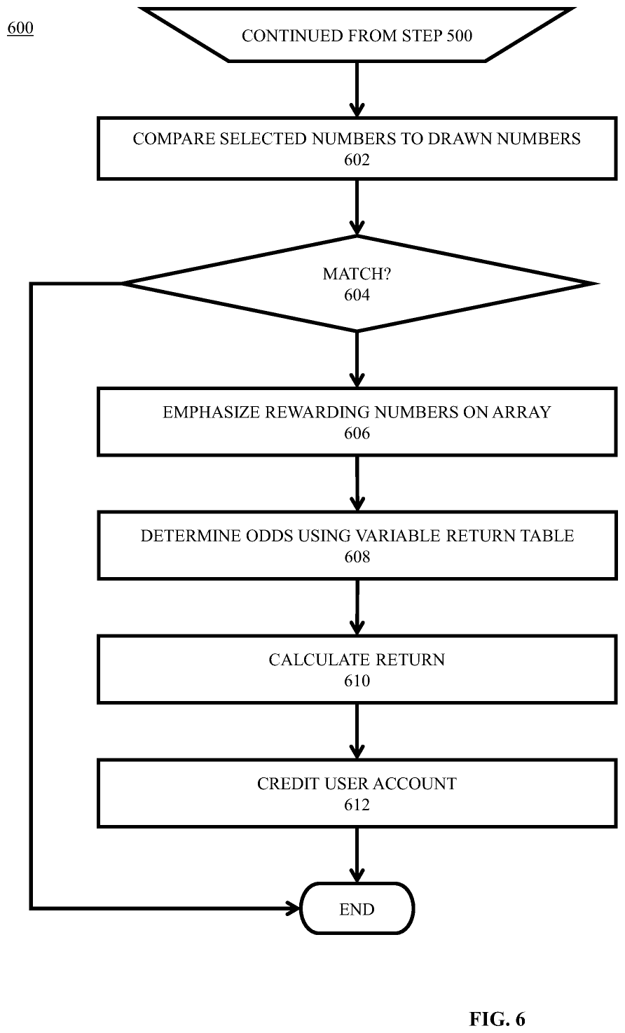

FIG. 6 is a flowchart providing more detail of step 600 of FIG. 2. The operation is continued from step 500 of FIG. 2 and, in step 602, the system may be configured to compare numbers selected by a user to drawn numbers corresponding to times of a goal scored during an event, such as a timed sporting event. In decision step 604, the system may determine whether one or more user-selected numbers match the one or more drawn numbers.

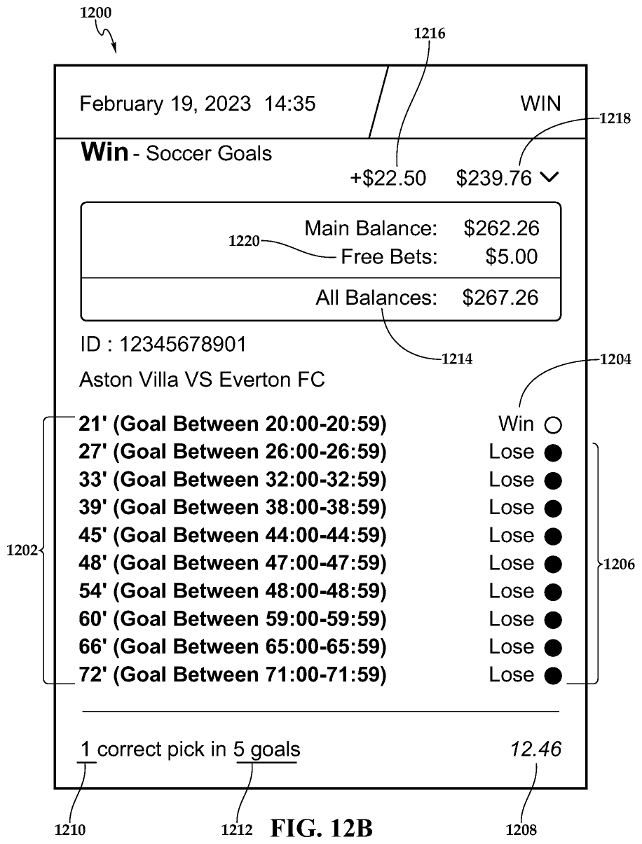

If at decision step 604, the system determine that there is at least one match between selected numbers and drawn numbers, in step 606, the system may emphasize those matching numbers—i.e., rewarding numbers—on an array. In step 608, the system may access a variable returns table to determine return odds. As described above, the returns table may be variable based on the one or more numbers selected, the one or more drawn numbers, and the one or more rewarding numbers, see FIGS. 13A-13C. In step 610, the system may calculate the return. For instance, the system may apply an equation, such as multiplying the determined odds by the user's sum. In step 612, the system may credit the corresponding user account according to the calculated return.

Exemplary Graphic User Interface

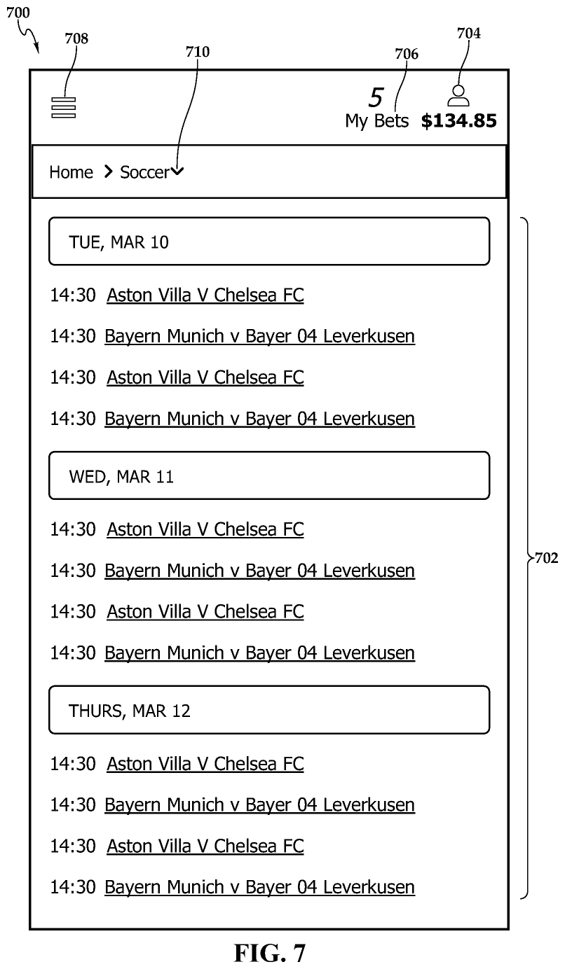

FIG. 7 illustrates a graphical user interface 700 of an exemplary list 702 of sporting events. User interface 700 may further include various icons corresponding to, for example, a user's account 704, user sums 706, and other menu options 708.

List 702 may display sporting events based on various user preferences. For instances, list 702 may be arranged in any suitable manner, such as in alphabetical or chronological order. Further, sporting events output on user interface 700 may be categorized according to a specific sport, a specific league, a specific team, a specific date, and the like.

By selecting a dropdown icon 710, the user may change the category. For example, instead of the depicted list 702 of “Soccer” matches, user interface 700 may output available hockey matches in response to a user selection via dropdown 710. Once a sporting event has been selected, such as through an input via interface 700, a user may be presented with an array corresponding to the selected event, as detailed below.

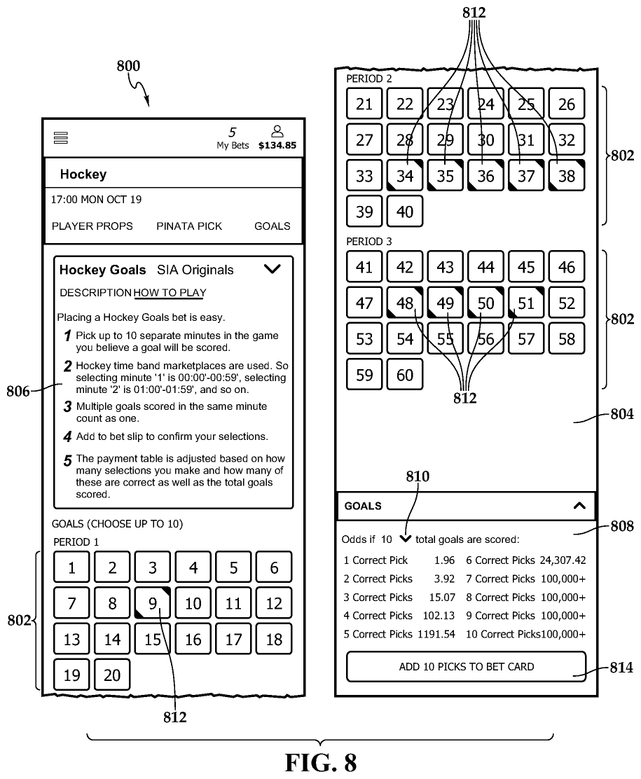

FIG. 8 illustrates a graphical user interface corresponding to exemplary array 800. Array 800 includes a number set 802 in a field 804 divided into a plurality of squares arranged in rows and columns. As shown, number set 802 may include sixty squares based on, for example, the regulation time of a hockey match, i.e., sixty minutes 800 may further include indicia 806, such as instructions on how to participate in the interactive activity. For instance, the instructions may relate to the number of squares that a user may select, how drawn numbers are identified, and adjustments that may be made to the returns table.

As further shown in FIG. 8, exemplary array 800 may include a returns table 808. Returns table 808 may be variable based on the quantity of numbers selected, the quantity of drawn numbers (i.e., time of goals scored during hockey match), and the quantity of rewarding numbers, as detailed above. For instance, the returns table may be variable based on a user input corresponding to changing a dropdown 810 corresponding to a number of goals scored during the corresponding hockey match.

Further, as illustrated in the exemplary array 800 of FIG. 8, the system may be configured to emphasize—e.g., highlight or accentuate—received user inputs corresponding to the selected numbers 812, i.e., numbered squares “9,” “34,” “35, “36,” “37,” “38,” “48,” “49,” “50,” and “51.” The system may be configured to determine that the user has selected ten numbers and adjust returns table 808 to output associated return odds. Although the system may output associated return odds, it is contemplated that returns table 808 may be further adjusted prior to, during, or after the start of the event. Further, a button 814 may be output to confirm a user's inputs, such as inputs corresponding to selected numbers 812.

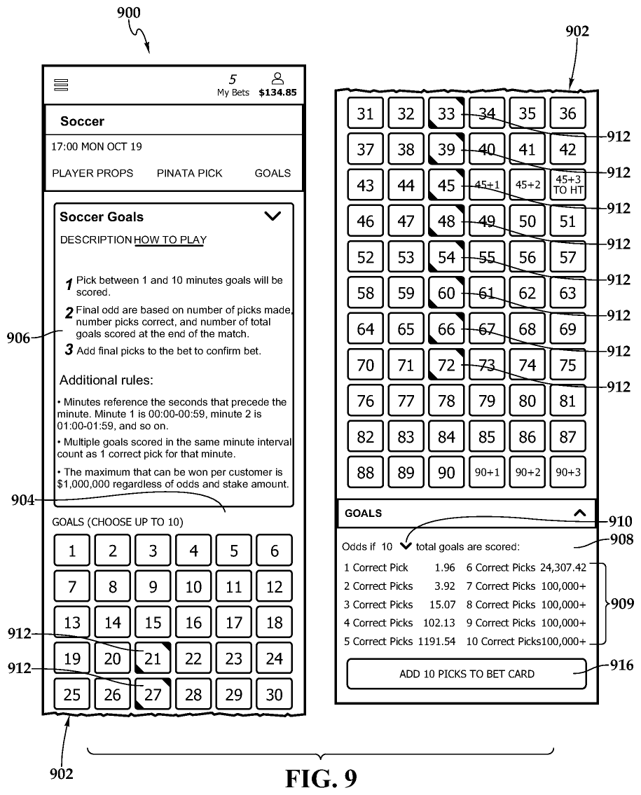

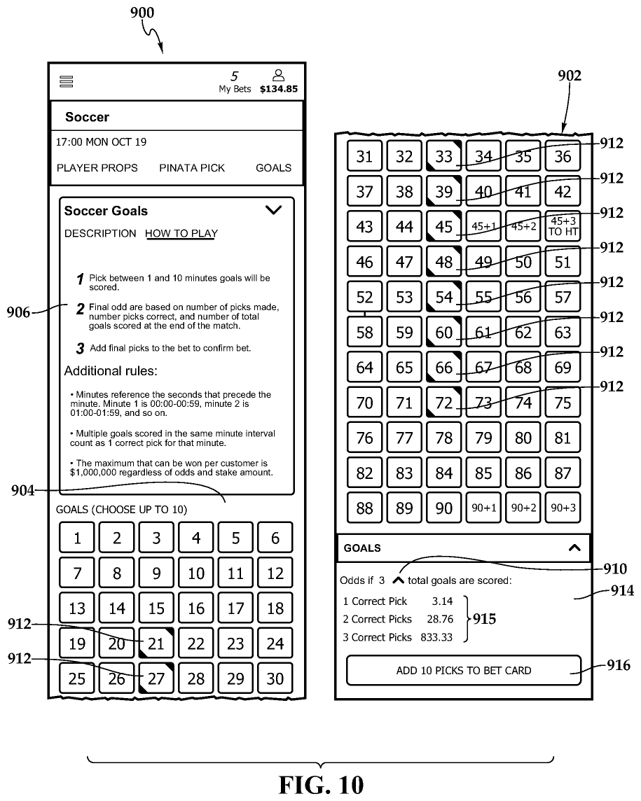

FIGS. 9-10 illustrates another exemplary array 900. Array 900 may include a number set 902 in a field 904 divided into a plurality of squares arranged in rows and columns. As shown, number set 902 may include a quantity of squares based on, for example, the regulation time of a soccer match (i.e., ninety minutes) including injury and added time. Exemplary array 900 may further include indicia 906, such as instructions on how to participate in the activity. For instance, the instructions may relate to the number of squares that a user may select and how the system identifies drawn numbers.

As further shown in FIG. 9, exemplary array 900 may include a returns table 908. Returns table 908 may be variable based on the quantity of numbers selected, the quantity of drawn numbers (i.e., time of goals scored during soccer match), and the quantity of rewarding numbers, as detailed above. For instance, the returns table may be variable based on a user input corresponding to changing the dropdown 910 to represent a number of goals scored during the corresponding soccer match.

Further, as illustrated in the exemplary array 900, the system may be configured to emphasize—e.g., highlight or accentuate—received user inputs corresponding to selected numbers 912, i.e., numbered squares “21,” “27,” “33,” “39,” “45,” “48,” “54,” “60,” “66,” and “72.” As shown in FIG. 9, the system may be configured to determine that the user has selected ten numbers and adjust returns table 908 to output return odds 909 corresponding to a conclusion of the match having ten goals. Alternatively, as shown in FIG. 10, in response to detecting a change via dropdown 910 to three goals, the system may adjust return odds 915 to output returns table 914. Although the system may output associated return odds, it is contemplated that returns tables 908, 914 may be further adjusted based on one or more predefined settings, such as setting a maximum return amount. Further, a selectable button 916 may be output to confirm a user's inputs, such as inputs corresponding to selected numbers 912.

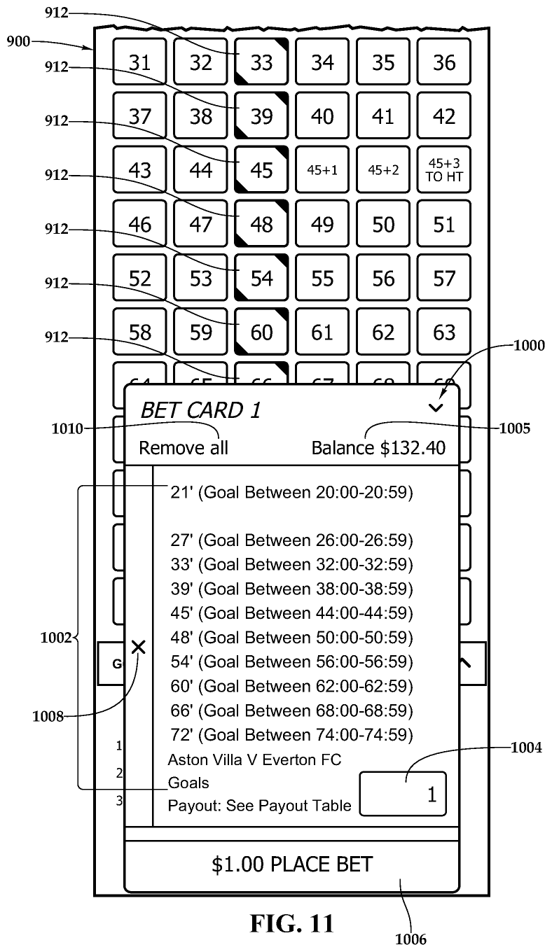

FIG. 11 illustrates an exemplary card 1000. In particular, the system may be configured to generate card 1000. Card 1000, as shown, may overlay array 900. Further, card 1000 may be based on user-selected numbers 912 of array 900. As shown, card 1000 may organize selected numbers 912, such as in a list 1002. List 1002 may be arranged in any suitable manner, such as chronological order. Further, card 1000 may include an input field 1004 for receiving a user input. User input may correspond to a sum corresponding to each selected number 912.

As shown, card 1000 may also include a balance 1005 corresponding to the funds or credits associated with the user account placing the sum. If a user is satisfied with their inputs, e.g., selected numbers 912 and/or input via field 1004, they may confirm those inputs via confirmation button 1006. If, however, the user wishes to return to array 900, such as to add or remove certain selected numbers 912, they may press the exit button 1008. Alternatively, if the user wishes to start over and clear array 900, they may do so by selecting or pressing the “Remove all” icon/text 1010.

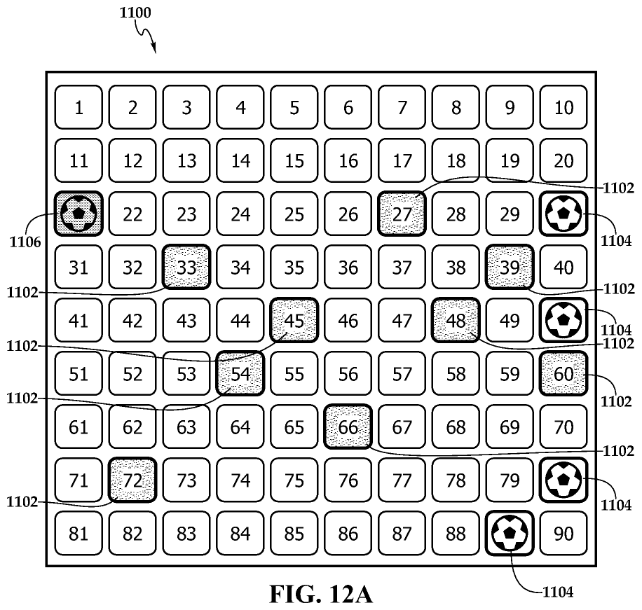

FIG. 12A and FIG. 12B illustrate exemplary outputs via a user interface once a user has confirmed a sum, such as via card 1000. In particular, FIG. 12A illustrates an output board 1100 may be based on array 900 of FIG. 10. As shown, the system may emphasize one or more numbers from number set 902 corresponding to, for example, selected numbers, drawn numbers, and rewarding numbers. In particular, as illustrated, selected numbers may be highlighted (illustrated as hatched lines 1102), drawn numbers may be overlaid with a graphical icon 1104, such as an icon of a soccer ball, and rewarding numbers may include combination 1106 of highlighting and an overlaid graphical icon. While output board 1100 may correspond to an event that has concluded, it is further contemplated that the system may be configured to emphasize dynamically selected, drawn, and rewarding numbers at any point between the start of an event and its conclusion.

Further, as shown in FIG. 12B, a user may also be presented with output card 1200. Output card 1200 may be based on output board 1100 of FIG. 12A. In particular, output card 1200 may present in list form or any other suitable form selected numbers 1202 and their corresponding results, i.e., “win” 1204 or “lose” 1206. Output card 1200 may further depict return odds 1208 based on a variable returns table of the system corresponding to, for example, a rewarding number quantity 1210 and a drawn number quantity 1212. Other information presented via output card 1200 may include an updated account balance 1214, which the system may calculate by adding a rewarding amount 1216 to a previous balance 1218 and other available credits and/or funds 1220 corresponding to the user account.

Exemplary Variable Returns Table

FIGS. 13A-13C illustrate exemplary returns tables that may be variable based on the one or more user-selected numbers, the one or more drawn numbers (i.e., time of goals scored during event), and the one or more rewarding numbers (matching selected numbers to drawn numbers), as detailed above.

FIG. 13A illustrates a variable returns table 1300 in which four goals were scored and three numbers were picked. As shown, if the system determines that three rewarding numbers were selected, the suggested odds are “25,000.” If the system determines that two rewarding numbers were selected, the suggested odds are “202.10.” If the system determines that one rewarding numbers were selected, the suggested odds are “6.89.” While FIGS. 13A-13C illustrate odds in a decimal format, e.g., “200.00,” on returns table, any suitable format is contemplated, such as a fraction format, e.g., “200/1,” or in terms of money line odds, e.g., “+20000.”

FIG. 13B and FIG. 13C illustrate two additional exemplary returns tables. Returns table 1310 of FIG. 13B a corresponds to an activity in which four goals were scored and eight numbers were picked. Returns table 1320 of FIG. 13C corresponds to an activity in which eight goals were scored and four numbers were picked. The variability of returns tables of the system may be understood in view of returns tables 1300, 1310, 1320. For instance, the odds for three rewarding numbers is “25,000,” “542.54,” and “1,785.71” in returns tables 1300, 1310, 1320, respectively. In contrast to conventional systems having a fixed returns table based on a predetermined quantity of drawn numbers, as a result of the uncertainty of drawn numbers, the system disclosed includes a variable returns table. As such, the system may be configured to facilitate interactions during the activity and prove a better and fuller experience.

Exemplary Computer System

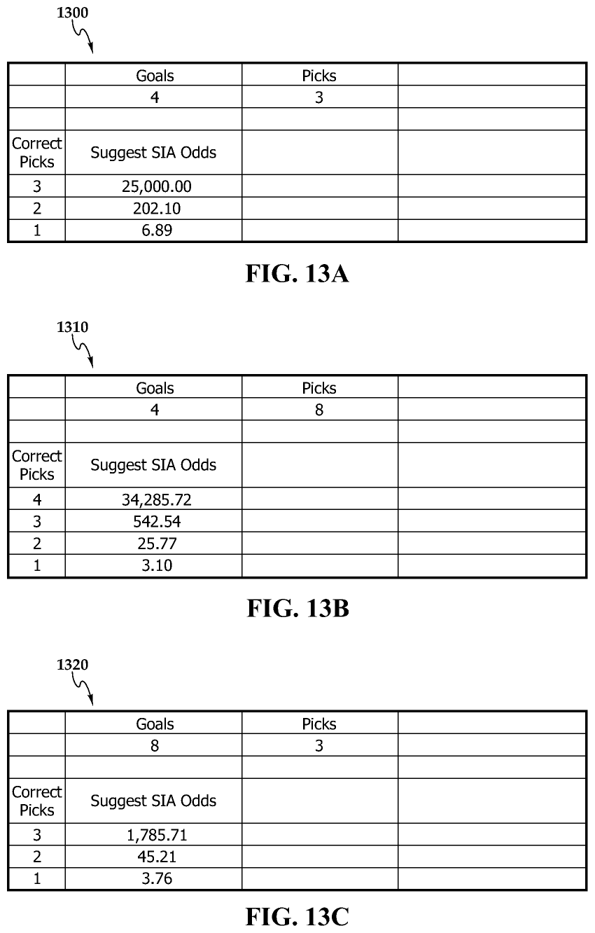

FIG. 14 illustrates a diagram of a system of which may be an embodiment of the present invention. Computer system 1400 includes an input/output interface 1401 connected to communication infrastructure 1403— such as a bus—which forwards data such as graphics, text, and information, from the communication infrastructure 1403 or from a frame buffer (not shown) to other components of computer system 1400. Input/output interface 1401 may be, for example, a display device, a keyboard, touch screen, joystick, trackball, mouse, monitor, speaker, printer, Google Glass® unit, web camera, any other computer peripheral device, or any combination thereof, capable of entering and/or viewing data.

Computer system 1400 may further include one or more processors 1405, which may be a special purpose or a general-purpose digital signal processor configured to process certain information. Computer system 1400 also includes a main memory 1407, for example random access memory (RAM), read-only memory (ROM), mass storage device, or combinations of each. Computer system 1400 may also include a secondary memory 1409 such as a hard disk unit 1411, a removable storage unit 1413, or combinations of each. Computer system 1400 may also include a communication interface 1415, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that main memory 1407, secondary memory 1409, communication interface 1415, or combinations of each, function as a computer usable storage medium, otherwise referred to as a computer readable storage medium, to store and/or access computer software including computer instructions. For example, computer programs or other instructions may be loaded into computer system 1400 such as through a removable storage device, for example, a floppy disk, ZIP disks, magnetic tape, portable flash drive, optical disk such as a CD or DVD or Blu-ray, Micro-Electro-Mechanical Systems (MEMS), nanotechnological apparatus. Specifically, computer software including computer instructions may be transferred from removable storage unit 1513 or hard disc unit 1411 to the secondary memory 1409 or through the communication infrastructure 703 to main memory 1407 of computer system 1400.

Communication interface 1415 allows software, instructions and data to be transferred between computer system 1400 and external devices or external networks. Software, instructions, and/or data transferred by communication interface 1415 are typically in the form of signals that may be electronic, electromagnetic, optical or other signals capable of being sent and received by communication interface 1415. Signals may be sent and received using wire or cable, fiber optics, a phone line, a cellular phone link, a Radio Frequency (RF) link, wireless link, or other communication channels.

Computer programs, when executed, enable the computer system 1400, particularly processor 1405, to implement the disclosed methods according to computer software including instructions.

Computer system 1400 described may perform any one of, or any combination of, the steps of any of the methods according to the invention. It is also contemplated that the methods according to the invention may be performed automatically.

Computer system 1400 of FIG. 14 is provided only for purposes of illustration, such that the invention is not limited to this specific embodiment. It is appreciated that a person skilled in the relevant art knows how to program and implement the invention using any computer system.

Exemplary Cloud Computing System

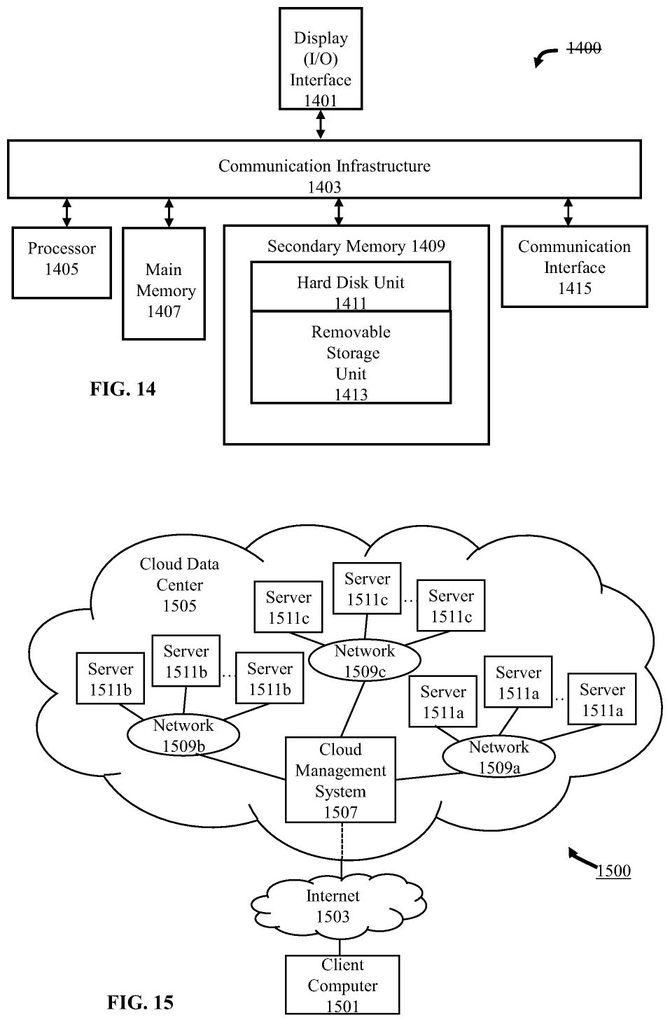

FIG. 15 illustrates an exemplary cloud computing system 1500 that may be an embodiment of the present invention. Cloud computing system 1500 includes a plurality of interconnected computing environments. Cloud computing system 1500 utilizes the resources from various networks as a collective virtual computer, where the services and applications can run independently from a particular computer or server configuration making hardware less important.

Specifically, the cloud computing system 1500 includes at least one client computer 1501, such as computer system 1400. Client computer 1501 may be any device through the use of which a distributed computing environment may be accessed to perform the methods disclosed herein, for example, a traditional computer, portable computer, mobile phone, personal digital assistant, tablet to name a few. The client computer 1501 includes memory such as random access memory (RAM), read-only memory (ROM), mass storage device, or any combination thereof. The memory functions as a computer usable storage medium, otherwise referred to as a computer readable storage medium, to store and/or access computer software and/or instructions.

The client computer 1501 also may include a communications interface, for example, a modem, a network interface (such as an Ethernet card), a communications port, a PCMCIA slot and card, wired or wireless systems, etc. The communications interface allows communication through transferred signals between the client computer 1501 and external devices including networks such as the Internet 1503 and cloud data center 1505. Communication may be implemented using wireless or wired capability such as cable, fiber optics, a phone line, a cellular phone link, radio waves or other communication channels.

The client computer 1501 establishes communication with the Internet 1503—specifically to one or more servers—to, in turn, establish communication with one or more cloud data centers 1505. A cloud data center 1505 includes one or more networks 1509a, 1509b, 1509c managed through a cloud management system 1507. Each network 1509a, 1509b, 1509c includes resource servers 1511a, 1511b, 1511c, respectively. Servers 1511a, 1511b, 1511c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 1507 can comprise a dedicated or centralized server and/or other software, hardware, and network tools to communicate with one or more networks 1509a, 1509b, 1509c, such as the Internet or other public or private network, with all sets of resource servers 1511a, 1511b, 1511c. The cloud management system 1507 may be configured to query and identify the computing resources and components managed by the set of resource servers 1511a, 1511b, 1511c needed and available for use in the cloud data center 1505. Specifically, the cloud management system 1507 may be configured to identify the hardware resources and components such as type and amount of processing power, type and amount of memory, type and amount of storage, type and amount of network bandwidth and the like, of the set of resource servers 1511a, 1511b, 1511c needed and available for use in the cloud data center 1505. Likewise, the cloud management system 1507 can be configured to identify the software resources and components, such as type of Operating System (OS), application programs, and the like, of the set of resource servers 1511a, 1511b, 1511c needed and available for use in the cloud data center 1505.

The present invention is also directed to computer products, otherwise referred to as computer program products, to provide software to the cloud computing system 1500. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (MEMS), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 1500 of FIG. 15 is provided only for purposes of illustration and does not limit the invention to this specific embodiment. It is appreciated that a person skilled in the relevant art knows how to program and implement the invention using any computer system or network architecture.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described in the application are to be taken as examples of embodiments. Elements and materials may be substituted for those illustrated and described in the application, parts and processes may be reversed, and certain features of the invention may be utilized independently, all as would be apparent to one skilled in the art after having the benefit of this description of the invention. Changes may be made in the elements described in the application without departing from the spirit and scope of the invention as described in the following claims.

What is claimed is:

1. A system for matching incidents to a list of numbers, comprising:
a processor; and
a memory storing a module with instruction executed by the processor, the processor operative to:
generate an array including a number set;
receive one or more inputs corresponding to a selection of one or more numbers from the number set;
define one or more drawn numbers of said number set based on event results;
compare said one or more selected numbers to the one or more drawn numbers to identify one or more rewarding numbers; and
credit, in response to determining the one or more rewarding numbers, a user account according to a returns table, said returns table is variable based on one or more parameters.

2. The system of claim 1, wherein said array corresponds to minutes of a timed sporting event.

3. The system of claim 2, wherein the sporting event includes at least one of a soccer match, a hockey match, a lacrosse match, a football match, basketball match, and a water polo match.

4. The system of claim 2, wherein said processor is further operative to obtain event results, wherein said event results correspond to one or more goals scored during said sporting match.

5. The system of claim 4, wherein said drawn numbers correspond to time of each of the one or more goals scored.

6. The system of claim 1, wherein said parameters include the one or more numbers selected, the one or more drawn numbers, and the one or more rewarding numbers.

7. The system of claim 1, wherein said processor is further operative to emphasize one or more numbers on said array.

8. The system of claim 7, wherein said one or more emphasized numbers include at least one of the one or more numbers selected, the one or more drawn numbers, and the one or more rewarding numbers.

9. The system of claim 1, wherein said processor is operative to obtain the one or more drawn numbers from a third party feed.

10. The system of claim 1, wherein said processor is further operative to calculate a return based on odds defined by said variable returns table.

11. A method for matching incidents to a list of numbers, comprising:
generating, by a server, an array including a number set;
receiving, by the server, a selection of one or more numbers from the number set;
defining, by the server, one or more drawn numbers of said number set based on event results;
determining, by the server, one or more rewarding numbers by comparing said one or more numbers selected to said one or more drawn numbers; and
crediting, in response to determining the one or more rewarding numbers, a user account according to a returns table, said returns table being variable based on one or more parameters.

12. The method of claim 11, wherein array corresponds to minutes of a timed sporting event.

13. The method of claim 12, wherein the sporting event includes at least one of a soccer match, a hockey match, a lacrosse match, a football match, basketball match, and a water polo match.

14. The method of claim 12, wherein said defining step further comprises obtaining event results corresponding to one or more goals scored during said sporting event.

15. The method of claim 14, wherein said drawn numbers correspond to time of each of the one or more goals scored.

16. The method of claim 11, wherein said parameters include the one or more numbers selected, the one or more drawn numbers, and the one or more rewarding numbers.

17. The method of claim 11, further comprising emphasizing one or more numbers on said array.

18. The method of claim 17, wherein said one or more emphasized numbers include at least one of the one or more numbers selected, the one or more drawn numbers, and the one or more rewarding numbers.

19. The method of claim 11, wherein said defining step further comprises obtaining the one or more drawn numbers from a third party feed.

20. The method of claim 11, wherein said crediting step further comprises calculating a return based on odds defined by said variable returns table.
